(19) United States
(12) Patent Application Publication
(10) Pub. No.: US 2026/0031489 A1
(43) Pub. Date: Jan. 29, 2026

(54) Connecting Device for Battery Cells of a Traction Battery, and Traction Battery

(71) Applicant: Bayerische Motoren Werke Aktiengesellschaft, Muenchen (DE)

(72) Inventors: Sebastian MAYR, Kutzenhausen (DE); Daniel SISAN, Muenchen (DE)

(21) Appl. No.: 18/994,134

(22) PCT Filed: Jul. 17, 2023
(86) PCT No.: PCT/EP2023/069743

§ 371 Date: Jan. 14, 2025

(30) Foreign Application Priority Data
Aug. 16, 2022 (DE) 10 2022 120 606.8

(51) Int. Cl. H01M 50/505; H01M 50/249; H01M 50/258; H01M 50/503; H01M 50/517; H01M 50/591

(52) U.S. Cl. CPC H01M 50/505; H01M 50/249; H01M 50/258; H01M 50/503; H01M 50/517; H01M 50/591

(57) ABSTRACT

A connecting device for battery cells of a traction battery compensates for tolerances between two battery cells in at least two spatial directions. The connecting device includes a bus bar, the first end of which is designed to be electrically connected to a first battery cell, and the second end of which is designed to be electrically connected to a second battery cell to electrically interconnect the two battery cells, and includes a fastening device via which the connecting device can be fastened in various relative positions to a housing component or a structural component of the traction battery for the purpose of tolerance compensation.

### BACKGROUND AND SUMMARY

The invention relates to a connecting device for battery cells of a traction battery, and to a traction battery for a motor vehicle.

EP 2 715 837 B1 discloses a cover for an electrochemical device which comprises a plurality of electrochemical cell. This cover comprises a carrier element, on which at least one cell connector for electrically conductively connecting a first cell terminal of a first electrochemical cell and a second cell terminal of a second electrochemical cell is arranged. Each cell connector comprises two contact regions for electrically contact-connecting in each case one cell terminal and a compensation region which connects the two contact regions to each other and is of elastically and/or plastically deformable design in order to render possible a movement of the two contact regions of the cell connector relative to each other during operation of the electrochemical device and/or for tolerance compensation for assembly of the electrochemical device. For this purpose, the compensation region can have one or more compensation shafts running transversely to a connecting direction.

DE 10 2014 003 911 A1 discloses a battery for a motor vehicle comprising at least one battery cell, which comprises at least one pole, and an electrical connecting element for electrically connecting the at least one pole of the battery cell, and a busbar for electrically connecting the at least one pole of the battery cell to a pole of a further battery cell. The electrical connecting element can therefore be used similarly to a conductive adhesive, with which the busbar can be fastened to the poles of the battery cells. The electrically conductive and at the same time elastically deformable connecting element can be used as a tolerance compensator.

Furthermore, WO 2009/080148 A2 discloses a cell connector for connecting two poles of cells of batteries which is in the form of a metal sheet. The cell connector has two openings, a respective compensation element being arranged between the cell connector and the pole in the region of each opening. Tolerance compensation in respect of the position of the pole is rendered possible owing to the arrangement of the compensation element in the opening of the cell connector.

An object of the invention is to provide a solution which renders possible tolerance compensation between two battery cells which are electrically connected to each other and also protection of the battery cells against damage due to mechanical loads.

This object is achieved by the subjects of the present disclosure. Further possible refinements of the invention are disclosed in the description and the figures. Features, advantages and possible refinements which are presented as part of the description for one of the subjects of the independent claims should be regarded at least analogously as features, advantages and possible refinements of the respective subject matter of the other independent claims and of every possible combination of the subjects of the independent claims, possibly in combination with one or more of the dependent claims.

The invention relates to a connecting device for battery cells of a traction battery, wherein the connecting device is designed to compensate for tolerances between two battery cells of the traction battery in at least two spatial directions. The traction battery is designed to provide electrical energy for an electric drive train of an electrically operable motor vehicle. Therefore, the electrically operable motor vehicle can be electrically driven by electrical energy from the traction battery, in particular from the battery cells of the traction battery. The traction battery comprises a large number of battery cells, which are electrically connected to each other. At least two of the battery cells of the traction battery can be electrically connected to each other by the connecting device. The connecting device can be designed to electrically connect battery cells of the same battery module or battery cells of different battery modules of the traction battery to each other. Tolerances between the battery cells to be connected can be compensated for by the connecting device. Constructions which exhibit tolerance compensation render possible compensation of faults or deviations within predefined tolerances. This means that faults or deviations between the battery cells to be connected to each other can be compensated for by the connecting device.

The connecting device comprises a busbar, which is designed to be electrically connected by way of its first end to a first battery cell and by way of its second end to a second battery cell, as a result of which the busbar electrically connects the two battery cells to each other. In particular, the busbar is designed to render possible tolerance compensation along its direction of longitudinal extent between the first battery cell and the second battery cell. Here, the busbar can, when the connecting device is in its installation position in the motor vehicle, in particular render possible tolerance compensation between the battery cells in the vehicle transverse direction and in the vehicle longitudinal direction.

The connecting device furthermore comprises a fastening device, via which the connecting device can be fastened to a housing component or a structural component of the traction battery for tolerance compensation in different relative positions. The housing component may be, for example, a bottom or a side wall or a cover of a housing of the electric traction battery. The structural component of the traction battery may be, for example, a reinforcing rib of the traction battery. By way of example, the housing of the traction battery can be braced by the reinforcing rib. On account of the connecting device being able to be fastened to the housing component or the structural component of the traction battery in the different relative positions, the connecting device can be displaced relative to the housing component or the structural component of the traction battery when compensating for tolerances between battery cells and therefore can be fastened to the housing component or the structural component without mechanical stress. By joining the connecting device to the housing component or the structural component of the traction battery via the fastening device, the mass of the connecting device is absorbed by the housing component or structural component of the traction battery. Furthermore, vibrations during operation or during travel of the motor vehicle can be absorbed via the housing component or the structural component. As a result, the battery cells can be protected against high loads, in particular against loads at respective interfaces of the battery cells at which the battery cells are mechanically connected to the connecting device, in particular the busbar. The connecting device therefore renders possible firstly connection of the battery cells to the tolerance compensator and secondly particularly good protection of the battery cells against damage.

In a further possible refinement of the invention, provision is made for the busbar to the designed to be rotatably connected via its first end to the first battery cell. This means that the busbar is placed, by way of its first end, onto the first interface of the first battery cell in a connecting direction and can be rotated relative to the first battery cell about this connecting direction. As a result, tolerance compensation between the first battery cell and the second battery cell is possible in directions running perpendicularly to the connecting direction. In other words, the connecting device is designed to prevent rotation between the first battery cell and the busbar. As a result, tolerance compensation takes place in the rotation plane of the busbar which is perpendicular to the connecting direction.

Provision is furthermore made for the busbar to have at its second end an elongate hole via which the busbar can be connected to the second battery cell displaceably relative to the second battery cell in order to compensate for tolerances between the battery cells. The elongate hole runs, in particular, with its longitudinal direction in the direction of longitudinal extent of the busbar. As a result, tolerance compensation in the direction of longitudinal extent of the busbar is possible. Tolerance compensation can therefore take place by the elongate hole along a straight line from the first interface of the first battery cell to the second interface of the second battery cell. It is therefore possible for the busbar to have a constant length, with tolerance compensation taking place along the direction of longitudinal extent of the busbar via the elongate hole provided at the second end of the busbar. As a result, the busbar can be manufactured in a particularly simple manner and has a particularly high degree of stability.

In a further possible refinement of the invention, provision is made for the connecting device to comprise a housing, which completely encloses the busbar. This housing serves for protection against direct contact and is in particular designed to electrically insulate the busbar. In particular, the housing covers the busbar at least substantially completely to the outside, as a result of which electrical contact between the busbar and components other than the battery cells connected to the busbar can be particularly reliably prevented. As a result, the risk of injury to persons and the risk of the connecting device to components of the traction battery shorting can be kept particularly low.

In this context, provision can be made in a development of the invention for the housing to comprise at least two housing elements, which can be displaced relative to each other along the direction of longitudinal extent of the busbar, each enclose the busbar over a length region along the direction of longitudinal extent of the busbar and mutually overlap in an overlap region, as a result of which the busbar is circumferentially enclosed by the two housing elements in the overlap region. Owing to the overlap between the housing elements in the overlap regions, the busbar is reliably and completely circumferentially enclosed by at least one of the housing elements along its entire length in each displacement position of the housing elements relative to each other. The busbar is covered by the respective housing elements perpendicularly to their direction of longitudinal extent to the outside. The adjacent housing elements mutually overlap in every displacement position of the housing elements, as a result of which the busbar is reliably electrically insulated to the outside at any time by the housing elements.

In this context, provision is made in a further possible refinement of the invention for one of the housing elements to have the fastening device. Owing to the ability to displace the housing elements relative to each other along the direction of longitudinal extent of the busbar, the fastening device can therefore be displaced relative to the busbar along the direction of longitudinal extent of the busbar. Owing to the ability to displace the fastening device along the direction of longitudinal extent of the busbar relative to the busbar, the fastening device—in different rotation positions of the busbar around its first end—can be arranged in overlap with the housing component or the structural component to which the fastening device is to be fastened. As a result, the fastening device can be connected to the housing component or to the structural component of the traction battery with the introduction of particularly little mechanical stress into the connecting device. Owing to the ability to displace the fastening device relative to the busbar along the direction of longitudinal extent of the busbar, it is possible to ensure that the fastening device can be securely connected to the housing component or the structural component of the traction battery, in spite of the tolerance compensation along the direction of longitudinal extent of the busbar.

In a further possible refinement of the invention, provision is made for at least three housing elements to be provided, wherein the housing element having the fastening device can be displaced both relative to a first housing element, which is associated with the first end of the busbar, and to a second housing element, which is associated with the second end of the busbar, along the direction of longitudinal extent of the busbar. As a result, the fastening device can be displaced relative to the first end and relative to the second end of the busbar along the direction of longitudinal extent of the busbar. Consequently, arrangement of the fastening device in the different positions relative to the housing component or the structural component of the traction battery is rendered possible and at the same time it is ensured that the busbar is completely surrounded by the housing and therefore reliably electrically insulated in each of the relative positions of the fastening device relative to the housing component or the structural component.

In a further possible refinement of the invention, provision is made for the fastening device to have an elongate hole. This elongate hole extends, with its length, in particular perpendicularly to the direction of longitudinal extent of the busbar. The length of the elongate hole is oriented obliquely or perpendicularly to the direction of longitudinal extent of the busbar. On account of the fastening device being displaceable relative to the busbar along the direction of longitudinal extent of the busbar and additionally having the elongate hole, the direction of longitudinal extent of which runs obliquely or perpendicularly to the direction of longitudinal extent of the busbar, the connecting device can be securely fastened via the fastening device to the housing component or the structural component in the different relative positions, with tolerance compensation at least in the two spatial directions by the connecting device being possible at the same time. A point at which the fastening device is fastened to the housing component or the structural component can therefore be moved relative to the busbar, in particular the rotation plane of the busbar, in order to render possible tolerance compensation two-dimensionally relative to the busbar.

In a further possible refinement of the invention, provision is made for the busbar to have a corrugation which, with its vertical direction, is perpendicular to the direction of longitudinal extent of the busbar, as a result of which tolerance compensation in the third spatial direction is rendered possible. This means that the corrugation rises perpendicularly to the rotation plane and therefore rises out of the rotation plane in which the busbar can be rotated relative to the first battery cell about the first end. In other words, the busbar has at least three bent portions in a length section, as a result of which the busbar has a corrugation-like raised portion. Owing to the corrugation of the busbar, the busbar has in the length section with the corrugation, a spring action in the vertical direction perpendicular to the rotation plane, as a result of which tolerance compensation between the first battery cell and the second battery cell can take place in this third spatial direction. In the length section having the corrugation, the busbar is elastically deformable on account of the bent portions of the corrugation, as a result of which height differences between the interfaces of the battery cells, at which interfaces the battery cells can each be connected to the busbar, can be compensated for in the vertical direction.

The invention furthermore relates to a traction battery for a motor vehicle, comprising a first battery cell, a second battery cell and a structural component or a housing component. The traction battery furthermore comprises a connecting device, which is electrically connected at one end to the first battery cell and at the other end to the second battery cell. The connecting device is displaceably held on the structural component or the housing component via a fastening device. Furthermore, the connecting device is designed to compensate for tolerances between two battery cells of the traction battery in at least two spatial directions. In particular, the connecting device compensates for tolerances between the first battery cell and the second battery cell at least in the two spatial directions, in particular in three spatial directions. The connecting device is, in particular, the connecting device described in conjunction with the connecting device according to the invention. On account of the connecting device being fastened to the structural component or the housing component, the connecting device is supported on the housing component or the structural component, as a result of which mechanical loads on respective interfaces of the battery cells, at which interfaces the battery cells are connected to the connecting device, can be kept particularly low. Owing to the connecting device being displaceably fastened to the structural component or the housing component, the tolerances between the first battery cell and the second battery cell can be particularly effectively compensated for or particularly large tolerances between the first battery cell and the second battery cell can be compensated for and at the same time it can be ensured that the connecting device is securely supported on the structural component or the housing component.

In one possible development of the invention, provision is made for the first battery cell to be part of a first battery module and the second battery cell to be part of a second battery module. The connecting device is therefore a module connector, via which the battery cells of the different battery modules of the traction battery are both mechanically and electrically connected to each other. The first battery cell of the first battery module and the second battery cell of the second battery module can be connected to each other by the connecting device in a particularly secure manner and with a particularly low risk of damage to the battery cells.

Further features of the invention can be found in the claims, the figures and the description of the figures. The features and combinations of features mentioned above in the description and the features and combinations of features disclosed in the description of the figures or in the figures alone can be used not only in the respectively indicated combination but also in other combinations or on their own, without departing from the scope of the invention.

### BRIEF DESCRIPTION OF THE DRAWINGS

FIG. 1 shows a schematic top view of a detail of a traction battery for a motor vehicle comprising a first battery cell, a second battery cell, a structural component and a connecting device; and

FIG. 2 shows a schematic perspective view of the connecting device.

### DETAILED DESCRIPTION OF THE DRAWINGS

Identical and functionally identical elements are provided with the same reference signs in the figures.

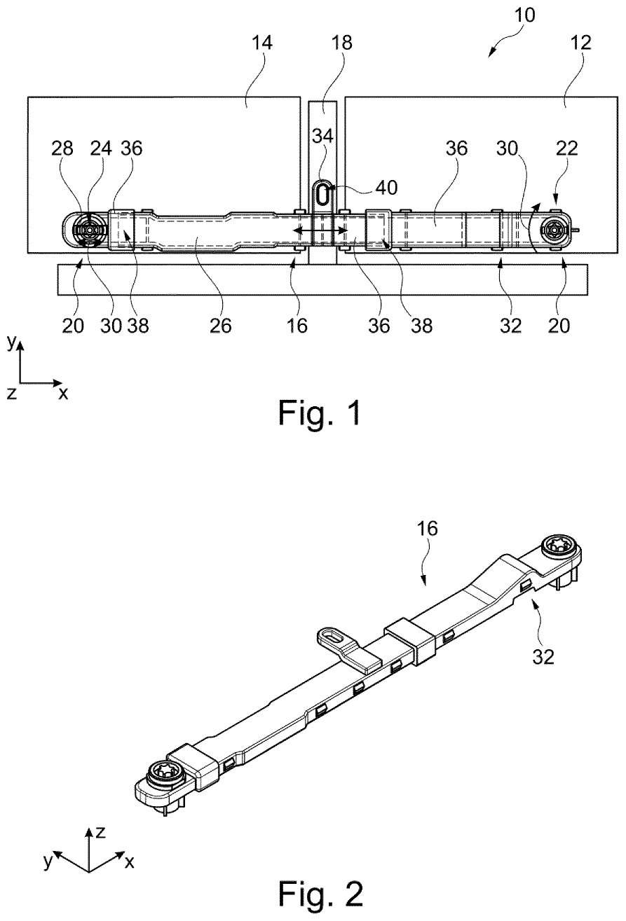

FIG. 1 shows a top view of a detail of a traction battery 10 for a motor vehicle. The traction battery 10 is designed to provide electrical energy for an electric drive train of the motor vehicle. Therefore, the motor vehicle can be driven by electrical energy from the traction battery 10. The traction battery 10 comprises a large number of battery cells, a first battery cell 12 and a second battery cell 14 of which are shown in FIG. 1. The first battery cell 12 is part of a first battery module of the traction battery 10 and the second battery cell 14 is part of a second battery module of the traction battery 10. The traction battery 10 furthermore comprises a connecting device 16, via which the first battery cell 12 is connected to the second battery cell 14. In the present case, the connecting device 16 is a module connector. A perspective view of the connecting device 16 is illustrated separately in FIG. 2.

FIG. 1 furthermore shows a structural component 18 of the traction battery 10. In the present case, the structural component 18 is a reinforcing rib of the traction battery 10. The connecting device 16 is designed to electrically connect respective interfaces 20 of the battery cells 12, 14, which interfaces are oriented in the vertical direction z of the vehicle in the installed position, to each other. The connecting device 16 is connected by way of its first end 22 via a first interface 20 to the first battery cell 12 and by way of its second end 24 via a second interface 20 to the second battery cell 14. The connecting device 16 has a busbar 26 for the purpose of electrically connecting the first battery cell 12 to the second battery cell 14. The busbar 26 is electrically contact-connected to the first battery cell 12 in the region of the first end 22 and electrically contact-connected to the second battery cell 14 in the region of the second end 24. The connecting device 16 is held at its first end 22 on the first battery cell 12 such that it can rotate about the vertical direction z of the vehicle. At the second end 24 of the connecting device 16, the second end being situated opposite the first end 22, the busbar 26 has an elongate hole 28, via which the busbar 26 is connected to the second battery cell 14. Tolerance compensation 30 between the first battery cell 12 and the second battery cell 14 along the direction of longitudinal extent of the busbar 26 is possible via the elongate hole 28, the length of which runs parallel to the direction of longitudinal extent of the busbar 26. Owing to the busbar 26 being rotatably held on the first interface 20 of the first battery cell 12, the busbar 26 can be pivoted in a plane spanned by the longitudinal direction x of the vehicle and the transverse direction y of the vehicle for tolerance compensation 30. Therefore, tolerance compensation 30 between the first battery cell 12 and the second battery cell 14 can therefore take place particularly effectively via the busbar 26 in the longitudinal direction x of the vehicle and in the transverse direction y of the vehicle when the traction battery 10 is in the installed position.

In order to render possible tolerance compensation in the vertical direction z of the vehicle, the connecting device 16 has a corrugation 32 in a length region, the corrugation, with its vertical direction, being perpendicular to the direction of longitudinal extent of the busbar 26. Owing to the corrugation 32, tolerances in the vertical direction z of the vehicle between the battery cells 12, 14 can be compensated for by the busbar 26, without the busbar 26 being raised by way of its respective ends from the interfaces 20 of the battery cells 12, 14.

The connecting device 16 furthermore comprises a fastening device 34, via which the connecting device 16 is fastened to the structural component 18 of the traction battery 10. This fastening device 34 is held on one of several housing elements 36 of the connecting device 16. In the present case, the connecting device 16 comprises three housing elements 36, a first of which is associated with the first end 22, the second of which is associated with the second end 24 and the third of which has the fastening device 34. The housing elements 36 are displaceable relative to each other along the direction of longitudinal extent of the busbar 26. The busbar 26 is fully electrically insulated to the outside by the housing elements 36 in every sliding position of the housing elements 36 relative to each other. This means that the busbar 26 is completely enclosed by the housing elements 36. The housing elements 36 are of electrically insulated design.

In order to render possible relative displacement of the housing elements 36 along the direction of longitudinal extent of the busbar 26 and at the same time to ensure that the busbar 26 is completely enclosed to the outside by the housing elements 36 in each relative position of the housing elements 36 in relation to each other, respective overlap regions 38 are provided, in which adjacent housing elements 36 mutually overlap in a length section of the busbar 26. This means that the busbar 26 is enclosed over the outer circumference by the two adjacent housing elements 36 in the respective overlap regions 38. Therefore, one of the housing elements 36 encloses the adjacent housing element 36 over the outer circumference in the respective overlap regions 38. The overlap regions 38 serve to provide protection against direct contact in order to ensure that the busbar 26 is fully electrically insulated to the outside at all times.

On account of the third housing element 36 being able to move both relative to the first end 22 and also relative to the second end 24 of the busbar 26, it is possible to ensure with tolerance compensation 30 along the direction of longitudinal extent of the busbar 26 that the connecting device 16 can be fastened to the structural component 18 via the fastening device 34. For this purpose, provision can additionally be made for the fastening device 34 to have an elongate hole 40, the length of which runs perpendicularly to the direction of longitudinal extent of the busbar 26 and perpendicularly to the direction of vertical extent of the corrugation 32. In the present case, the length of the elongate hole 40 runs in the transverse direction y of the vehicle. The connecting device 16 can be screwed to the structural component 18 via the elongate hole 40.

The connecting device 16 is designed to dissipate vibrations via the structural connection to the structural component 18, these vibrations possibly occurring on account of a free length of the busbar 20 and leading to damage to the connecting device 16 or the battery cells 12, 14 connected to the connecting device 16 via the interfaces 20. This permanently integrated structural connection can compensate for large tolerances in a compact installation space.

In the connecting device 16, provision is made for protection against direct contact, which is a plastic housing for the busbar 26 clipped in a monocoque structure, to be split into three assemblies, in the present case the three housing elements 36. The middle housing element 36 has the fastening device 34, which is the structural connection and therefore a holder for a screw connection. This middle housing element 36 is mounted on the busbar 26 in a longitudinally displaceably manner. As a result, tolerances in the longitudinal direction can be compensated for on the holder in the longitudinal direction of the busbar 26. The elongate hole 40 is provided on the fastening device 34, the elongate hole, with its length, being oriented obliquely or perpendicularly to the busbar 26 and being inserted in the holder. As a result, tolerances can be compensated for transversely to the direction of longitudinal extent of the busbar 26.

In the traction battery 10 which is in the form of a high-voltage accumulator, two battery modules are electrically connected to each other by the connecting device 16 in the form of a module connector. The module connector is fastened to the structural component 18 or to a housing of the high-voltage accumulator by the integrated holder. With this design, tolerances between battery cells 12, 14 associated with the interfaces 20 of the different battery modules and therefore tolerance compensation of length along the direction of longitudinal extent of the busbar 26 and in the plane at the screw-connection point of the holder on the structural component 18 of the high-voltage accumulator can be compensated for. Tolerance compensation along the direction of longitudinal extent of the busbar 26 and, in the present case, in the longitudinal direction x of the vehicle takes place via the position of the holder between the two interfaces 20, and tolerance compensation perpendicular to the direction of longitudinal extent of the busbar 26 and therefore, in the present case, in the transverse direction y of the vehicle takes place via the distance between the busbar 26 and a bore hole in the structural component 18, via which the connecting device 16 is fastened to the structural component 18 of the traction battery 10 by the elongate hole 40.

Overall, the present disclosure discloses how the busbar 26 in the form of a cell connector or else module connector with protection against direct contact and structural connection with integrated tolerance compensation in at least two spatial directions can be provided.

### LIST OF REFERENCE SIGNS

10 Traction battery
12 First battery cell
14 Second battery cell
16 Connecting device
18 Structural component
20 Interface
22 First end
24 Second end
26 Busbar
28 Elongate hole
30 Tolerance compensation
32 Corrugation
34 Fastening device
36 Housing clement
38 Overlap region
40 Elongate hole

1-10. (canceled)

11. A connecting device for battery cells of a traction battery, wherein the connecting device is configured to compensate for tolerances between two battery cells of the traction battery in at least two spatial directions, the connecting device comprising:
a busbar configured to be electrically connected by a first end of the busbar to a first battery cell and by a second end of the busbar to a second battery cell, wherein the busbar is configured to electrically connect the two battery cells to each other; and
a fastening device configured to fasten the connecting device to a housing component or a structural component of the traction battery for tolerance compensation in different relative positions.

12. The connecting device according to claim 11,
wherein the busbar is configured to be rotatably connected via the first end to the first battery cell, and
wherein the busbar comprises at the second end an elongate hole via which the busbar is configured to be connected to the second battery cell displaceably relative to the second battery cell in order to compensate for tolerances between the battery cells.

13. The connecting device according to claim 11,
wherein a housing is provided that completely encloses the busbar.

14. The connecting device according to claim 13,
wherein the housing comprises at least two housing elements, which can be displaced relative to each other along a direction of longitudinal extent of the busbar, wherein each of the at least two housing elements enclose the busbar over a length region and mutually overlap in an overlap region, such that the at least two housing elements circumferentially enclose the busbar in the overlap region.

15. The connecting device according to claim 14,
wherein one of the housing elements has the fastening device.

16. The connecting device according to claim 15,
wherein at least three housing elements are provided, wherein the housing element having the fastening device is configured to be displaced both relative to a first housing element, which is associated with the first end of the busbar, and relative to a second housing element, which is associated with the second end of the busbar, along the direction of longitudinal extent of the busbar.

17. The connecting device according to claim 11,
wherein the fastening device has an elongate hole.

18. The connecting device according to claim 11,
wherein the busbar comprises a corrugation that, with a vertical direction of the busbar, is perpendicular to a direction of longitudinal extent of the busbar, as a result of which tolerance compensation in a third spatial direction is rendered possible.

19. A traction battery for a motor vehicle, comprising:
a first battery cell;
a second battery cell;
a structural component or a housing component; and
a connecting device, which is electrically connected at one end to the first battery cell and at another end to the second battery cell, which connecting device is displaceably held on the structural component or the housing component via a fastening device, and is configured to compensate for tolerances between the first and second battery cells of the traction battery in at least two spatial directions.

20. The traction battery according to claim 19,
wherein the first battery cell is part of a first battery module, and the second battery cell is part of a second battery module.

21. The traction battery according to claim 19,
wherein the connecting device comprises:
a busbar configured to be electrically connected by a first end of the busbar to the first battery cell and by a second end of the busbar to the second battery cell, wherein the busbar is configured to electrically connect the two battery cells to each other.

22. The traction battery according to claim 21,
wherein the busbar is configured to be rotatably connected via the first end to the first battery cell, and
wherein the busbar comprises at the second end an elongate hole via which the busbar is configured to be connected to the second battery cell displaceably relative to the second battery cell in order to compensate for tolerances between the battery cells.

23. The traction battery according to claim 21, comprising:
a housing that completely encloses the busbar.

24. The traction battery according to claim 23,
wherein the housing comprises at least two housing elements, which can be displaced relative to each other along a direction of longitudinal extent of the busbar, wherein each of the at least two housing elements enclose the busbar over a length region and mutually overlap in an overlap region, such that the at least two housing elements circumferentially enclose the busbar in the overlap region.

25. The traction battery according to claim 24,
wherein one of the housing elements has the fastening device.

26. The traction battery according to claim 25,
wherein the housing comprises at least three housing elements, wherein the housing element having the fastening device is configured to be displaced both relative to a first housing element, which is associated with the first end of the busbar, and relative to a second housing element, which is associated with the second end of the busbar, along the direction of longitudinal extent of the busbar.

27. The connecting device according to claim 21,
wherein the busbar comprises a corrugation that, with a vertical direction of the busbar, is perpendicular to a direction of longitudinal extent of the busbar, as a result of which tolerance compensation in a third spatial direction is rendered possible.

28. The traction battery according to claim 19,
wherein the fastening device has an elongate hole.
